(19) United States
(12) Patent Application Publication
(10) Pub. No.: US 2019/0253797 A1
(43) Pub. Date: Aug. 15, 2019

(54) Operation Reception Device and Audio Mixer

(71) Applicant: Yamaha Corporation, Hamamatsu-shi (JP)

(72) Inventors: Shintaro NOGUCHI, Hamamatsu-shi (JP); Hiroshi KOTAKI, Hamamatsu-shi (JP)

(21) Appl. No.: 16/269,674

(22) Filed: Feb. 7, 2019

(30) Foreign Application Priority Data
Feb. 9, 2018 (JP) 2018-021822

(51) Int. Cl. H04R 3/04; H01H 13/18

(52) U.S. Cl. CPC H04R 3/04; H04R 2430/01; H04R 2420/01; H01H 13/186

(57) ABSTRACT

An operation reception device includes a display to display a current value, a physical operator to receive an operation in a one-way direction, and a controller configured to when the physical operator is not being operated by the user, set as a reference state an operating state corresponding to the current value, and in response to user operation of the physical operator, change the current value of the reference state.

### CROSS REFERENCE TO RELATED APPLICATIONS

This Nonprovisional application claims priority under 35 U.S.C. § 119(a) on Patent Application No. 2018-021822 filed in Japan on Feb. 9, 2018 the entire contents of which are hereby incorporated by reference.

### BACKGROUND OF THE INVENTION

### 1. Field of the Invention

A preferred embodiment of the present invention relates to an operation reception device that receives an operation of a user and to an audio mixer including such an operation reception device.

### 2. Description of the Related Art

Japanese Unexamined Patent Application Publication No. 2009-236972 discloses an audio mixer including an electric motor and a fader. The fader according to Japanese Unexamined Patent Application Publication No. 2009-236972 is moved by the electric motor. The audio mixer according to Japanese Unexamined Patent Application Publication No. 2009-236972 includes LEDs arranged adjacent to the fader. The LEDs display a current level.

In addition, Japanese Unexamined Patent Application Publication No. H09-097063 discloses an electronic musical instrument that is able to perform volume control by wheeling.

However, an electric motor is heavy and large and requires high cost. On the other hand, in a case of a fader without an electric motor, even when a level is changed during a scene recall, the position of the fader does not change, so that the level that is displayed by a display such as an LED may not correspond to the position of the fader.

A wheel shaped operator makes it difficult for a user to intuitively grasp a level. In addition, since the wheel shaped operator needs to perform a rotation operation, it is difficult to operate a plurality of operators all at once.

### SUMMARY OF THE INVENTION

In view of the foregoing, a preferred embodiment of the present invention provides an operation reception device and an audio mixer that solve at least one of the above various problems.

An operation reception device includes a display to display a current value, a physical operator to receive an operation in a one-way direction, and a controller configured to when the physical operator is not being operated by the user, set as a reference state an operating state corresponding to the current value, and in response to user operation of the physical operator, change the current value of the reference state.

The above and other elements, features, characteristics, and advantages of the present invention will become more apparent from the following detailed description of the preferred embodiments with reference to the attached drawings.

### BRIEF DESCRIPTION OF THE DRAWINGS

FIG. 1 is a view showing a portion of an operation panel of an audio mixer 1.

FIG. 2 is a plan view of a lever 10.

FIG. 3 is a side view of the lever 10.

FIG. 4 is a block diagram showing a configuration of the audio mixer 1.

FIG. 5 is a functional block diagram of signal processing to be performed in a signal processor 23 and a CPU 25.

FIG. 6 is a flow chart showing an operation of the CPU 25.

FIG. 7A, FIG. 7B, FIG. 7C, and FIG. 7D are views showing a problem in a case of providing a fader 601 as a physical operator as a reference example.

FIG. 8A, FIG. 8B, and FIG. 8C are views to illustrate advantages of the lever 10 according to a preferred embodiment of the present invention.

FIG. 9 is a view showing an example in which a display such as an LCD or an OLED displays a current value.

FIG. 10 is a view showing an example in which the display displays a screen of a parametric equalizer and the lever 10 receives a selection of a frequency to be level-adjusted.

### DETAILED DESCRIPTION OF THE PREFERRED EMBODIMENTS

An operation reception device according to various preferred embodiments of the present invention is lighter in weight, smaller in size, and lower in cost than a conventional art. The operation reception device does not cause such a problem that a level that is displayed by a display such as an LED and the position of a physical operator do not correspond to each other. In addition, a user can intuitively grasp a current level. In a case in which a plurality of physical operators are arranged, the user can also operate the plurality of physical operators all at once.

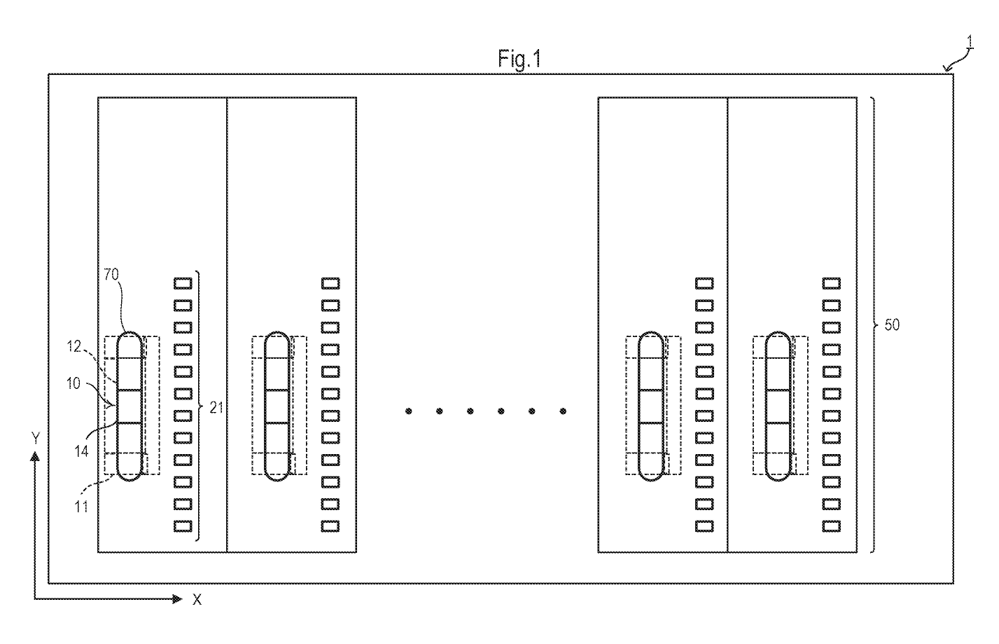

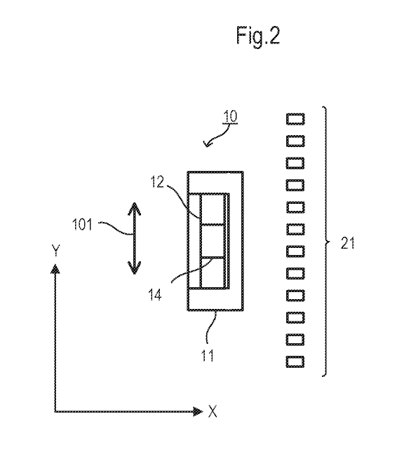

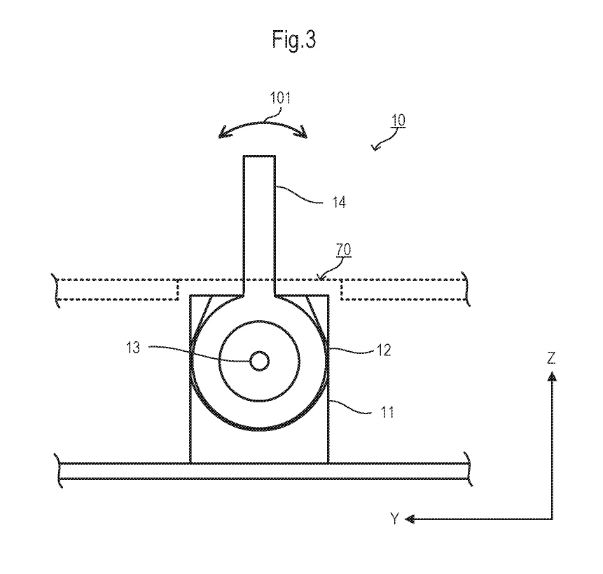

FIG. 1 is a view showing a portion of an operation panel of an audio mixer 1. FIG. 2 is a plan view of a lever 10, and FIG. 3 is a side view of the lever 10.

The audio mixer 1, as shown in FIG. 1, includes an operation panel and a channel strip 50 on the operation panel. The channel strip 50 is an area in which a plurality of physical operators to receive various types of operations from a user are arranged for each channel. In FIG. 1, as an example of a physical operator, the lever 10 is disposed for each channel.

The lever 10, as shown in FIG. 2, has a rectangular shape in a plan view. The lever 10, as shown in FIG. 3, is made of a cylindrical shaped portion 12 and a rectangular parallelepiped shaped portion 14. The center 13 of the cylindrical shaped portion 12 is rotatably supported with respect to a seat 11. As a result, the lever 10 is able to rotate around the center 13 in a rotational direction 101. In other words, the lever 10, in the plan view, is able to move in a one-way direction (the Y direction).

The rectangular parallelepiped shaped portion 14 of the lever 10 has a shape extending long in a height direction (the Z direction) and short in a width direction (the X direction) and a length direction (the Y direction). The rectangular parallelepiped shaped portion 14 protrudes from a groove 70 provided in the operation panel, in the Z direction. The cylindrical shaped portion 12 is hidden below the operation panel. It is to be noted that, while a portion that protrudes from the groove 70 of the operation panel has a rectangular parallelepiped shape and a portion that is hidden in the operation panel has a cylindrical shape in this example, each shape of the portions according to the present invention is not limited to a rectangular parallelepiped shape and a cylindrical shape.

The groove 70 extends thin and long in a one-way direction (the Y direction in the example of FIG. 1), and has a rectangle shape in a plan view. The lever 10, when receiving an operation (a pressing operation) in the one way direction from a user, rotates and tilts in the one-way direction.

The lever 10 is held at a predetermined position by a not-shown elastic member such as a spring. The predetermined position, as shown in FIG. 3, is a position at which the rectangular parallelepiped shaped portion 14 is disposed in the Z direction. The lever 10 is returned to the predetermined position by the elastic member in a case in which the operation from a user is stopped.

In addition, the channel strip 50 includes an LED group 21 disposed for each channel. The LED group 21 includes a plurality of LEDs disposed in the Y direction. The LED group 21 is an example of a display that displays a current value. In this example, the LED group 21 displays a level for each channel as a current value. In a case in which the level of a channel is at a minimum (minus infinity dB), all the LEDs of the LED group 21 are turned off. As the level is increased, an LED on the lowermost side (on the side of the negative Y direction) among the LED group 21 is turned on first, remaining LEDs are turned on from an LED on the lower side in order, and all the LEDs are turned on at the maximum level.

It is to be noted, on the operation panel, in addition to the lever 10 and the LED group 21 that are shown in FIG. 1, any number of knobs, buttons, and the like may be provided.

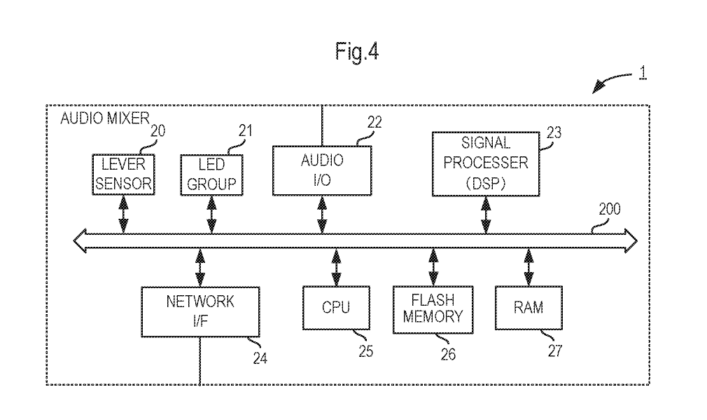

FIG. 4 is a block diagram showing a configuration of the audio mixer 1. The audio mixer 1 includes a lever sensor 20, an LED group 21, an audio I/O 22, a signal processor (DSP) 23, a network I/F 24, a CPU 25, a flash memory 26, and a RAM 27.

The CPU 25 is a control portion that controls the operation of the audio mixer 1. The CPU 25 performs various types of operations by reading a predetermined program stored in the flash memory 26 being a storage medium to the RAM 27 and executing the program. For example, the CPU 25 sets a parameter of various types of signal processing in the signal processor 23 in response to a motion of the lever 10 detected by the lever sensor 20. A current value of the parameter of various types of signal processing is stored in a current memory that is allocated to the flash memory 26 or the RAM 27.

It is to be noted that the program that the CPU 25 reads out does not need to be stored in the flash memory 26 in a self device. For example, the program may be stored in a storage medium of an external device such as a server. In such a case, the CPU 25 may read a program from the server to the RAM 27 in each case and may execute the program.

The signal processor 23 is composed of a DSP configured to perform various types of signal processing. The signal processor 23 performs signal processing such as mixing, a level adjustment, equalizing, or compression imparting, to the audio signal to be inputted through the audio I/O 22 or the network I/F 24. The signal processor 23 outputs the audio signal to which the signal processing has been applied, to another device through the audio I/O 22 or the network I/F 24.

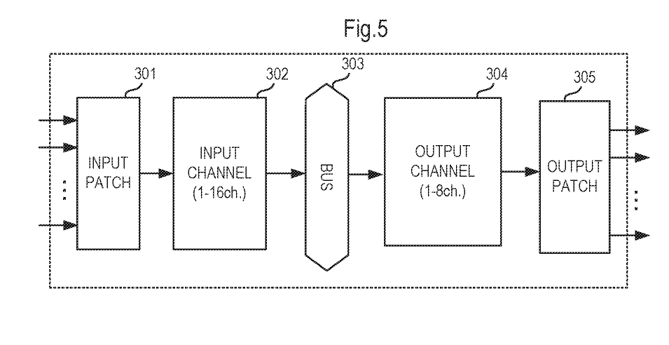

FIG. 5 is a functional block diagram of signal processing to be performed in the signal processor 23 and the CPU 25. As shown in FIG. 5, the signal processing is functionally performed by an input patch 301, at least one input channel 302, a bus 303, an output channel 304, and an output patch 305.

The input patch 301 receives an audio signal inputted from the audio I/O 22 or the network I/F 24. The input patch 301 assigns an inputted audio signal to at least one channel among a plurality of input channels (32 channels, for example). As a result, the audio signal is supplied to each channel of the input channels 302.

The each channel of the input channels 302 performs various types of signal processing such as equalizing or effect imparting including compressing. The each channel of the input channels 302, after adjusting the level of a signal-processed audio signal, sends the audio signal out to the bus 303 provided in a subsequent stage. The lever 10 is a physical operator to receive an adjustment amount of this level adjustment from a user.

The bus 303 receives an audio signal inputted from each channel of the input channels 302. The bus includes a stereo bus to output an audio signal to a main speaker, an AUX bus to output an audio signal to another device such as an effector, or a MIX bus to output an audio signal to a monitor speaker.

The output channel 304 has a plurality of output channels (8 channels, for example). Each channel in the output channels 304, similarly to the input channels, performs various types of signal processing including the level adjustment, to an audio signal to be inputted. The each channel of the output channels 304 sends a signal-processed audio signal out to the output patch 305. The lever 10 is a physical operator to receive an adjustment amount of this level adjustment in the output channels from a user. The output patch 305 assigns each channel to a device (including an analog audio output terminal or a digital audio output terminal) on an output side. As a result, the signal-processed audio signal is output to other devices.

As described above, the lever 10 corresponds to a physical operator for the level adjustment of the input channel or the output channel. When a user operates the lever 10, the CPU 25 provides an instruction to the signal processor 23 by rewriting the content of the current memory in order to perform level adjustment in response to the operation of the lever 10 detected by the lever sensor 20.

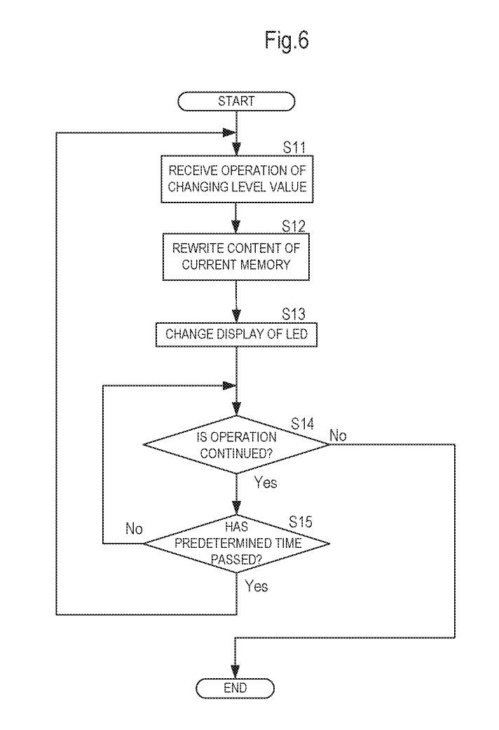

FIG. 6 is a flow chart showing an operation of the CPU 25. The CPU 25 is a lever sensor 20 and performs the operation of this flow chart in a case of detecting an operation to the lever 10.

The CPU 25 sets as a reference a case in which the operation to the lever 10 is not performed, and receives an operation of changing a relative level value to the reference when the lever 10 is pulled in an upward direction (the Y direction) or in a downward direction (the negative Y direction) (S11). The CPU 25 rewrites the content of the current memory in response to the operation of changing a level value (S12). The CPU 25 changes a display mode of the LED group 21 according to the content of the current memory (S13).

For example, the CPU 25 increases the level value of a corresponding channel by one stage (1 dB, for example) when the lever 10 is pulled in the upward direction (the Y direction). The CPU 25 increases the adjustment amount of the level adjustment that the DSP 23 performs, by one stage, by rewriting the content of the current memory.

The CPU 25 checks whether or not the operation to the lever 10 is continued (S14). The CPU 25 ends the operation in a case of determining that the operation to the lever 10 is not continued (No in S14).

The CPU 25, in a case of determining that the operation to the lever 10 is continued (Yes in S14), further checks whether or not duration of the operation has passed a predetermined time (1 second, for example) or longer (S15). The CPU 25, in a case in which the duration of the operation has not passed a predetermined time (1 second, for example) or longer (No in S15), repeats determination in S14.

The CPU 25, in a case of determining that the duration of the operation has passed a predetermined time (1 second, for example) or longer (Yes in S15), repeats the operation from S11, receives the operation of changing a level value, and rewrites the content of the current memory. The CPU 25 increases the level value of a corresponding channel by one stage for each lapse of a predetermined time (1 second, for example), for example, in a case in which the lever 10 keeps being pulled in the upward direction (the Y direction).

In this manner, the CPU 25 sets the case in which the operation to the lever 10 being a physical operator is not performed, as a reference, and, in a case in which the operation to the lever 10 is performed, functions as a controller that receives the operation as the operation of changing a relative value.

As described above, the lever 10 shown in the present preferred embodiment, even without a heavy, large, and costly component such as an electric motor, does not cause such a problem that the level to be displayed by the display of the LED group 21 or the like and the position of a physical operator do not correspond to each other.

Generally, the audio mixer includes a scene memory that stores a value of various types of parameters. A user simply instructs to call a scene memory and can rewrite the content of the current memory with the value set in the past. As a result, the user can immediately call the optimal value for each scene that has been set during a rehearsal of a concert, for example. Such a reproducing operation is called “a scene recall.”

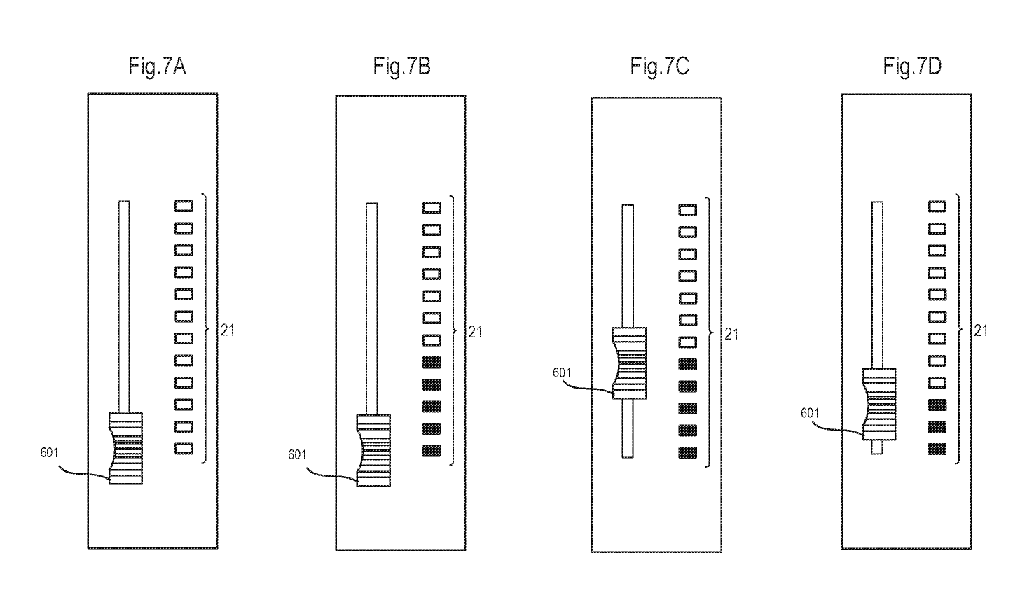

FIG. 7A, FIG. 7B, FIG. 7C, and FIG. 7D are views showing a problem in a case of providing a fader 601 as a physical operator as a reference example.

In the state of FIG. 7A, the fader 601 is at the lowermost position that is set to the minimum level value (minus infinity dB, for example). In such a case, all the LEDs of the LED group 21 are turned off. When a user performs a scene recall and the CPU 25 rewrites the content of the current memory in this state, the level value is changed, as shown in FIG. 7B, so that the lighting state of the LEDs of the LED group 21 is changed. In the example of FIG. 7B, five LEDs are turned on. Accordingly, the user can grasp that the adjustment amount of the current level in a corresponding channel is increased. However, in a case in which the fader 601 does not include an electric motor, the position of the fader 601 does not change. In such a case, the position of the fader 601 and the level displayed by the LED group 21 do not correspond to each other.

Even when the user desires to operate the fader 601 and to decrease the level, the user cannot decrease the level since the fader 601 is at the lowermost position. Therefore, in a conventional method, as shown in FIG. 7C, the user first moves the fader 601 manually to the position of the level displayed by the LED group 21, for example. The user manually matches the level displayed by the LED group 21 and the position of the fader 601, as shown in FIG. 7D, and then performs level adjustment by moving the fader 601 to a level to which the user actually desires to adjust the level.

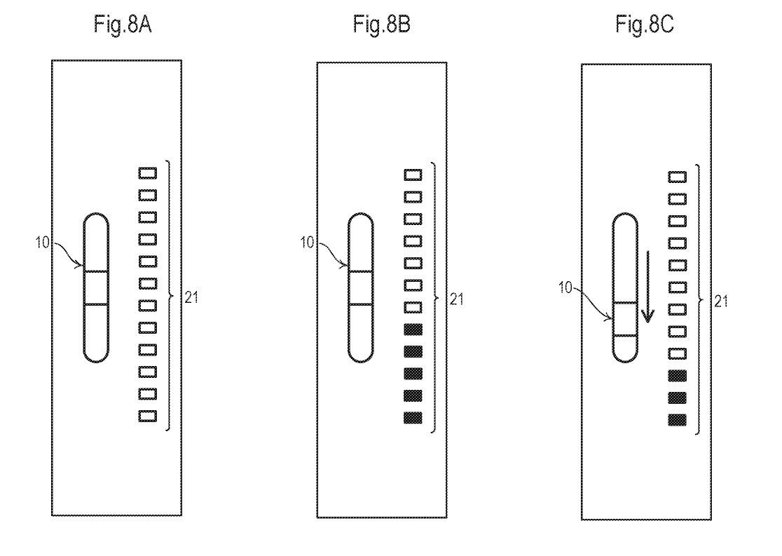

On the other hand, the audio mixer 1 according to the present preferred embodiment includes the lever 10 as a physical operator. The lever 10 is returned to a predetermined position by the elastic member such as a spring in a case in which the operation from a user is stopped. Accordingly, as shown in FIG. 8A and FIG. 8B, even when a user performs a scene recall, the CPU 25 rewrites the content of the current memory, and the lighting state of the LEDs of the LED group 21 is changed, the problem that the position of the physical operator and the level displayed by the LED group 21 do not correspond to each other does not occur.

In addition, the CPU 25 according to the present preferred embodiment sets as a reference a case in which the operation to the physical operator such as the lever 10 is not performed, and receives the operation as an operation of changing a relative value in a case in which the operation to the physical operator is performed. Accordingly, as shown in FIG. 8C, the user can perform the level adjustment by moving the lever 10 in the downward direction even immediately after a scene recall.

Further, the physical operator according to the present preferred embodiment, having no problem that the position of the physical operator and the level displayed by the LED group 21 do not correspond to each other, does not need to mount a heavy, large and costly component such as an electric motor. Accordingly, the audio mixer 1 according to the present preferred embodiment is drastically lighter in weight, smaller in size, and lower in cost than a conventional art.

The audio mixer 1 of the present preferred embodiment displays a current value by the LED group 21, so that the user can intuitively grasp the current level. The lever 10, since being a physical operator that receives an operation in a one way direction, similarly to a conventional fader, is able to operate a plurality of operators all at once. In other words, the user can move a plurality of levers 10 all at once in a direction such as a downward direction by using a plurality of fingers or the entire arm. In particular, the audio mixer, in a case in which a problem such as howling occurs and the user cannot grasp at which channel the howling has occurred, needs an operation to promptly decrease the level of a plurality of channels. In such a case, the lever 10 of the present preferred embodiment, similarly to a conventional fader, is able to move the plurality of levers 10 all at once in a direction such as a downward direction.

It is to be noted that the above described preferred embodiment shows that the level value is changed by one stage in a case in which the lever 10 is operated once or in a case in which the duration of an operation has passed a predetermined time (1 second, for example) or longer. However, in a case in which the duration of the operation has passed a predetermined time (1 second, for example) or longer, it is not essential to change the level value by one stage.

In addition, the CPU 25 may change a change amount of a level value by the operation amount of the lever 10. For example, the CPU 25 changes the level value by one stage in a case in which the lever 10 is tilted at 0 to 5 degrees, and changes the level value by two stages in a case in which the lever 10 is tilted at 5 degrees or more. In this manner, as the angle at which a user tilts the lever 10 is increased, the change amount of the level value may be increased. As a result, the user, in a case of desiring to quickly change a level, makes the tilt of the lever 10 larger, so that the intention of the operation of a user is able to be reflected in the change amount of a level value. In such a case, the lever sensor 20, for example, includes a variable resistor or a multiple contact digital switch, and detects an operation amount of the lever 10. It is to be noted that, in the present preferred embodiment, the operation amount corresponds to an angle difference between a reference position (a position when an operation is not performed) and a current position. However, the operation amount may be an angle change per predetermined time. For example, the level value may be changed by two stages in a case in which the user tilts the lever 10 at 5 degrees, taking a short time (1 second, for example), or the level value may be changed by one stage in a case in which the user tilts the lever 10 at 5 degrees, taking a long time (5 seconds, for example).

In addition, the CPU 25 may change the change amount of a level value, depending on the length of duration of the operation. For example, the CPU 25 changes the level value by one stage in a case in which the operation of the lever 10 is continued for 1 second or longer, and changes the level value by two stages in a case in which the operation of the lever 10 is continued for 2 seconds or longer.

In addition, the CPU 25 may change a change amount of a level value, depending on a direction of operating the lever 10. The CPU 25, for example, changes the change amount of a level value, depending on a direction (a first direction) in which a level is increased and a direction (a second direction) in which a level is decreased. In particular, as described above, the audio mixer, in a case in which a problem such as howling occurs, needs an operation to promptly decrease the level of a plurality of channels. On the other hand, a level is slowly increased in many cases. Accordingly, the CPU 25, even when the operation amount is the same, causes the change amount of a level value to be increased more in the direction in which a level is decreased than in the direction in which a level is increased.

It is to be noted that the present preferred embodiment has shown the lever 10 as an example of a physical operator. However, a physical operator is not limited to the lever 10. For example, a pressure sensor, a digital switch, or a wheel is applicable as a physical operator of the present invention. However, the physical operator, regardless of a mode, similarly to a fader, may preferably receive an operation from a user in a one way direction. The physical operator, in a case in which the operation from the user is stopped, may preferably return to a predetermined position.

In addition, the physical operator, similarly to the lever 10, does not need to move physically. The physical operator may merely be a protrusion provided on the operation panel. In such a case, the CPU 25 detects an operation to the physical operator by a sensor (a piezoelectric sensor, for example) that receives a pressing operation of a user to the protrusion. In such a case, the elastic member to return the physical operator to a predetermined position is not required.

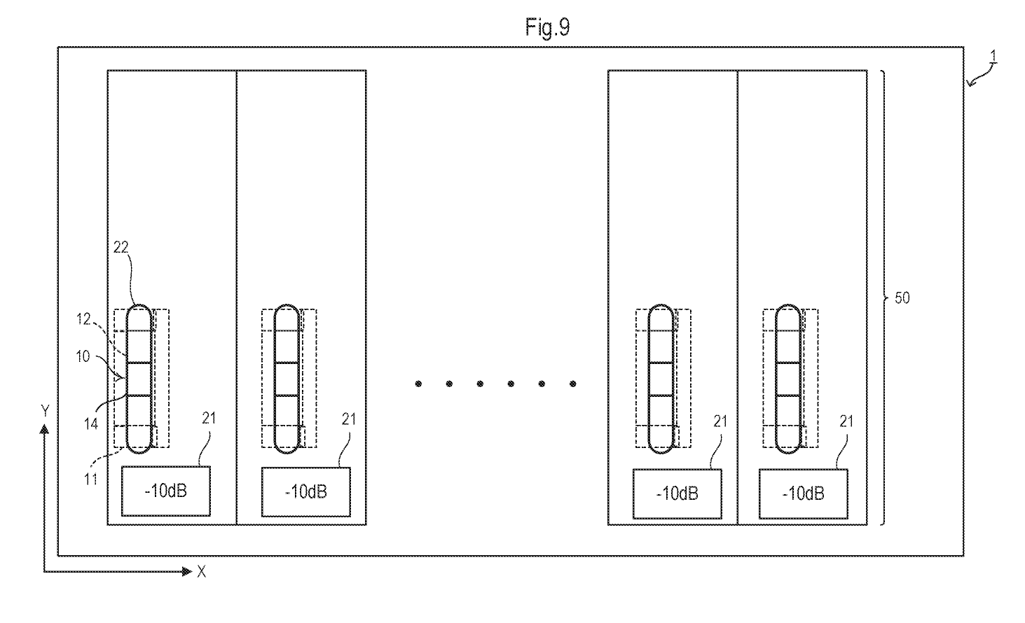

It is to be noted that a display that displays a current value is not limited to the LED group 21. For example, as shown in FIG. 9, a display such as an LCD (Liquid Crystal Display) or an OLED (Organic Light-Emitting Diode) may display a current value. In addition, a change in display color may indicate a level value. However, in a case in which a plurality of channels are provided, for example, in a case in which a plurality of displays corresponding to each parameter are arranged, the LED group 21 preferably includes an array shape so that current values are able to be easily compared.

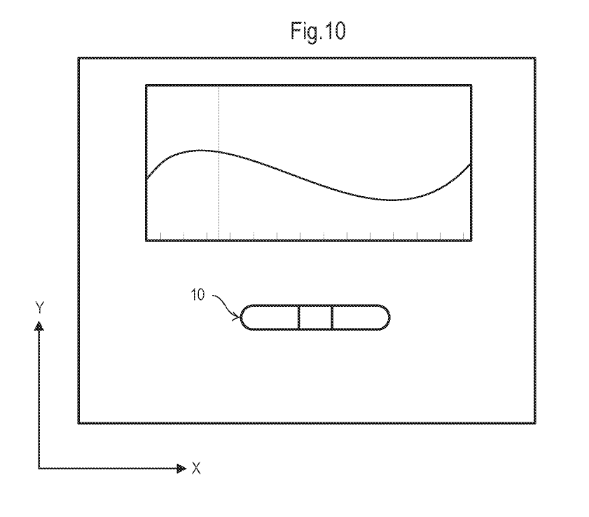

The physical operator is also not limited to a physical operator that receives an operation of changing a level value. FIG. 10 is a view showing an example in which the display displays a screen of a parametric equalizer and the lever 10 receives a selection of a frequency to be level-adjusted. In this example, the user can change the frequency to be level-adjusted by operating the lever 10 in a width direction (the X direction). As a matter of course, the lever 10 is also applicable to a case of receiving a selection of a target frequency in not only the parametric equalizer shown in FIG. 10 but also a graphic equalizer. In such a case, the user can adjust a gain for each frequency band by operating the lever 10 arranged for each frequency band.

In this manner, the CPU 25 may include any structure as long as the structure receives an operation of the physical operator as an operation of changing a parameter in the signal processor 23. It is to be noted that, as shown in the example of FIG. 10, the physical operator may be one and may not need to include a plurality of physical operators arranged for each channel.

The operation reception device according to the present invention is not limited to the example applied to the audio mixer. For example, the operation reception device according to the present invention is also applicable as an operation reception device to adjust the reproduction speed of contents. In addition, for example, the operation reception device according to the present invention is also applicable as an operation reception device to receive heating power adjustment of a gas stove or an induction heating cooker.

Finally, the foregoing preferred embodiments are illustrative in all points and should not be construed to limit the present invention. The scope of the present invention is defined not by the foregoing preferred embodiment but by the following claims. Further, the scope of the present invention is intended to include all modifications within the scopes of the claims and within the meanings and scopes of equivalents.

What is claimed is:

1. An operation reception device comprising:
a display to display a current value;
a physical operator to receive an operation in a one way direction; and
a controller configured to
when the physical operator is not being operated by a user, set as a reference state an operating state corresponding to the current value, and
in response to a user operation of the physical operator, change the current value.

2. The operation reception device according to claim 1, wherein the controller changes display of the display in response to the user operation of the physical operator.

3. The operation reception device according to claim 1, wherein the controller changes a change amount of the current value based on an amount of the user operation of the physical operator.

4. The operation reception device according to claim 1, wherein:
the physical operator receives the user operation in a first direction and a second direction; and
the controller changes a change amount of the current value based on the first direction and the second direction.

5. The operation reception device according to claim 1, wherein the physical operator is one of a plurality of physical operators.

6. The operation reception device according to claim 5, wherein:
the display is one of a plurality of displays; and
each of the plurality of displays is associated with a corresponding physical operator of the plurality of physical operators.

7. The operation reception device according to claim 5, wherein
the parameter is one of a plurality of parameters,
each of the plurality of physical operators is associated with each corresponding parameter of the plurality of parameters.

8. The operation reception device according to claim 7, wherein the plurality of parameters are related to sound.

9. The operation reception device according to claim 8, wherein the plurality of parameters are related to volume of sound.

10. The operation reception device according to claim 5, wherein each of the plurality of physical operators is associated with a corresponding channel of a plurality of sound channels.

11. The operation reception device according to claim 1, wherein the user operation of the physical operator is a pressing operation.

12. The operation reception device according to claim 1, wherein
the physical operator comprises:
a lever configured to tilt in response to the user operation in a first direction.

13. The operation reception device according to claim 12, wherein
the physical operator includes:
an elastic member configured to return the lever to a first position when the user is not operating the lever.

14. The operation reception device according to claim 1, wherein
the physical operator includes:
an elastic member configured to return a lever to a first position when the user is not operating the lever.

15. The operation reception device according to claim 12, further comprising an operation panel including a groove provided in the one way direction, wherein a portion of the lever protrudes from the groove.

16. An audio mixer comprising:
the operation reception device according to claim 1; and
a signal processor configured to process an audio signal, wherein the controller responds to the user operation of the physical operator by controlling a changing a parameter in the signal processor.
